(19) United States
(12) Patent Application Publication
(10) Pub. No.: US 2009/0252382 A1
(43) Pub. Date: Oct. 8, 2009

(54) SEGMENTATION OF IRIS IMAGES USING ACTIVE CONTOUR PROCESSING

(75) Inventors: Xiaomei Liu, Natick, MA (US); Kevin W. Bowyer, Granger, IN (US); Patrick J. Flynn, South Bend, IN (US)

Correspondence Address: CONNOLLY BOVE LODGE & HUTZ LLP, 1875 EYE STREET, N.W., SUITE 1100, WASHINGTON, DC, 20006, US

(73) Assignee: UNIVERSITY OF NOTRE DAME DU LAC, Notre Dame, IN (US)

(21) Appl. No.: 12/246,499

(22) Filed: Oct. 6, 2008

Related U.S. Application Data
(60) Provisional application No. 60/992,799, filed on Dec. 6, 2007.

(51) Int. Cl. G06K 9/00

(52) U.S. Cl. 382/117

(57) ABSTRACT

Aspects of the present invention are generally directed to processing of an obtained iris image. An iris is image is segmented for use in a biometric recognition scheme.

### CROSS-REFERENCE TO RELATED APPLICATIONS

This application claims priority from U.S. Provisional Patent Application No. 60/992,799 entitled, “SEGMENTATION OF IRIS IMAGES USING ACTIVE CONTOUR PROCESSING,” filed Dec. 6, 2007, which is hereby incorporated by reference herein.

### GOVERNMENT INTEREST

This invention is made with U.S. government support under Grant ID No. CNS-0130839 awarded by the National Science Foundation and Grant ID 2004-DD-BX-1224 awarded by the Department of Justice. The government has certain rights in this invention.

### BACKGROUND

1. Field of the Invention

The present invention relates generally to personal identification using biometric features derived from an image of a human iris, and more particularly, to segmentation of iris images using active contour processing.

2. Related Art

Iris recognition techniques are one of several biometric technologies used commercially for access control and identity verification. Generally, iris recognition includes three main components: iris segmentation, iris encoding and iris matching. During iris segmentation, the iris region is localized in an eye image by a computing system to select the image area occupied by the iris. This process includes identifying the boundary between the pupil and the innermost iris tissue, known as the pupillary boundary, and the boundary between the outermost iris tissue and the sclera, known as the limbic boundary.

Conventional iris recognition techniques are designed based on the assumption that the pupillary and limbic boundaries are well approximated by, for example, circles, ellipses, etc. Referring specifically to circular approximations, the assumption of boundary circularity is satisfied only if the iris is presented frontally to the camera, the eye in question has substantially circular iris boundaries, and the iris is not occluded by eyelashes or eyelids. In practice, however, these constraints are not always satisfied such as when an iris is not frontally presented to the camera. Moreover, in practice it is common for eyelids and eyelashes to occlude significant portions of the pupillary and limbic boundaries, thereby violating the circularity assumption. These deficiencies in conforming to the circularity assumption coupled with other limitations of existing iris segmentation techniques contribute to inaccuracies in iris recognition processes. Thus, while existing methods of iris segmentation have proven effective, the levels of accuracy may be improved upon.

### SUMMARY

In one aspect of the invention, a method for determining a contour representation of non-occluded regions in an iris image is provided. The method comprises: receiving an initial contour estimate of pupillary and limbic boundaries in the iris image which define an iris image area; determining an initial estimate of a noise boundary contour defining an area containing occluding data points within the iris image; executing an active contour function on the initial estimate of the noise boundary contour in an unwrapped representation of the iris image area to generate a revised noise boundary contour containing a revised set of occluding data points; and excluding from the initial contour estimate the revised set of occluding data points to generate a contour estimate of the non-occluded regions of the iris.

In another aspect of the invention, a method for refining an iris image is provided. The method comprises: receiving an initial contour estimate of pupillary and limbic boundaries in the iris image which define an iris image area; generating a polynomial representation of a selected one of the pupillary and limbic boundaries using the initial contour estimate of the selected boundary; executing an active contour method on the polynomial representation based on intensity data at the boundary of the representation; and generating a revised contour estimate of the selected boundary based on the execution of the active contour method thereby causing the revised estimate to more accurately represent the selected boundary.

In other embodiments a method for segmentation of an obtained iris image having at least one occluded region therein is provided. A Canny transform is performed on the obtained iris image to identify intensity gradients representing edge points within the iris image; performing a circular Hough transform on a plurality of the edge points to identify the pupillary and limbic boundaries within the iris image; performing at least one Radon transform to define two straight line segments each representing a boundary of the occluded region, wherein the occluded region is further bounded by one or more borders of the image; and removing the region bounded by the two straight line segments and the one or more borders from the iris image.

### BRIEF DESCRIPTION OF THE DRAWINGS

FIG. 1 is a high-level block diagram illustrating an apparatus in accordance with one embodiment of the present invention;

FIG. 2A is a high-level flowchart illustrating a method in accordance with embodiments of the present invention;

FIG. 2B is a detail level flow chart illustrating the operations performed to segment an iris image in accordance with an embodiment of the present invention;

FIG. 2C is a detail level flow chart illustrating the operations performed to segment an iris image in accordance with an embodiment of the present invention;

FIG. 3 depicts unwrapping an iris image from a circular to a rectangular image, in accordance with one embodiment of the present invention;

FIG. 4 depicts an image of a frontally presented human eye showing pupillary and limbic iris boundaries, in accordance with one embodiment of the present invention;

FIG. 5 depicts two circular boundaries superimposed on the iris image of FIG. 3 showing an inner circle corresponding to an initial approximation of a pupillary boundary and an outer circle corresponding to an initial approximation of a limbic boundary; and

FIGS. 6(a) through 6(e) depict the results of the application of embodiments of the present invention to the limbic boundary in an image of a partially closed eye.

### DETAILED DESCRIPTION

Aspects of the present invention are generally directed to processing an obtained iris image. Specifically, the obtained iris image is segmented for use in a biometric recognition scheme.

Embodiments of the invention use active contour processing to generate a refined iris image that image takes into account local image content and excludes, for example, occluded areas in an initial iris image from iris matching computations. For example, in one such embodiment, an initial noise boundary contour based on an evaluation of the intensity data in the iris image area is obtained. An active contour method is applied to the initial noise boundary contour to revise the initial noise boundary contour estimate. The revised estimate of the noise boundary contour is used to determine a refined iris image for use in iris matching operations. In certain embodiments, the iris image area defined by initial circular contour estimates of the limbic and pupillary boundaries is unwrapped into a rectangle prior to use of the active contour method to revise the initial noise boundary contour estimate. In other embodiments, the noise boundary contour is revised in the original image and the iris is not unwrapped to a rectangle.

Other embodiments using active contour processing generate a refined iris image by revising a representation of the pupillary and/or limbic boundary. In such embodiments, an initial estimate of either the pupillary or limbic boundary is obtained and a polynomial representation of the selected boundary is generated. This representation is revised using an active contour method based on intensity data at the boundary of the representation to more accurately represent the actual boundary in the iris image. The revised representation is used to generate a refined iris image for use in iris matching operations.

In alternative embodiments, the obtained iris is segmented to remove regions of the image occluded by, for example, eyelashes and/or eyelids. In one such embodiment, a Canny transform is performed on the obtained iris image to identify intensity gradients representing edge points within the iris image. A circular Hough transform is performed on a plurality of the edge points to identify the pupillary and limbic boundaries within the iris image. At least one Radon transform is performed to define two straight line segments. The straight line segments, along with the borders of the iris image, bound the occluded region. The region bounded by the two straight line segments and the iris image borders are removed from the iris image. This revised iris image having the occluded region removed is used in iris matching operations.

In one embodiment, the methods of the present invention are embodied in one or more computer software programs written in a structured computing language such as C for example, and adapted for use in conjunction with currently available iris imaging devices.

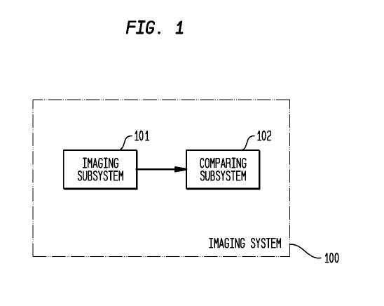

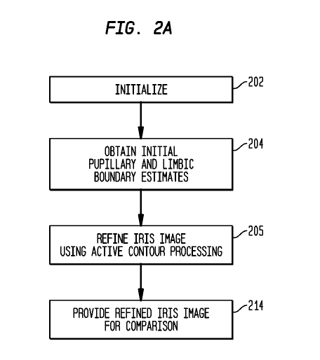

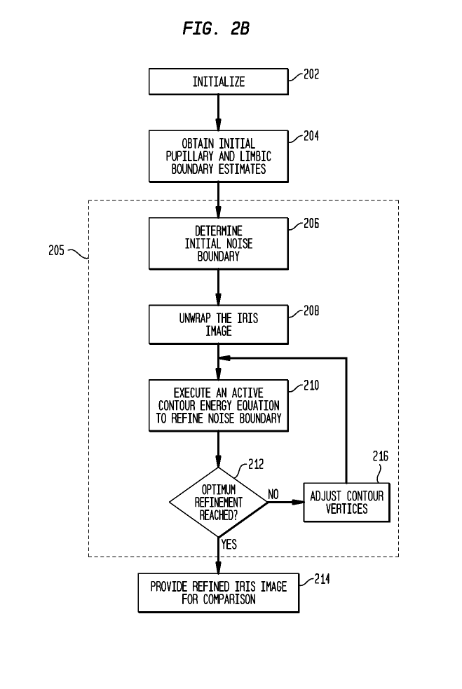

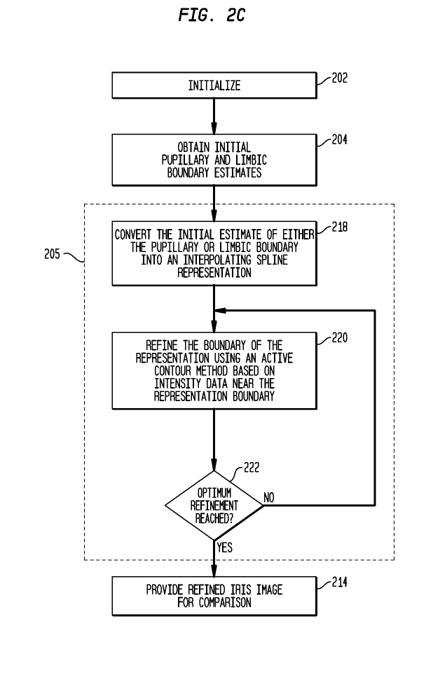

FIG. 1 is a high-level block diagram of an imaging system 100 in accordance with embodiments of the invention. FIG. 2A is a high-level flowchart illustrating a method in accordance with embodiments of the present invention using imaging system 100 illustrated in FIG. 1.

As shown in FIG. 1, imaging system 100 comprises an imaging subsystem 101 and a comparing subsystem 102. In this arrangement, imaging subsystem 101 may comprise any combination of hardware or software which executes the method of the present invention. In illustrative embodiments, imaging subsystem 101 comprises an image acquisition device and an algorithm that executes the method of the present invention. During operation, imaging subsystem 101 is initialized as shown by block 202 in FIG. 2A. At block 204, imaging subsystem 101 acquires an image of a scanned iris and creates an initial circular estimate of the pupillary and limbic boundaries of the scanned iris. At block 205, the iris image area defined by the pupillary and limbic boundaries may then be refined using an active contour method. For example, the iris image may be refined using one of the methods described below with reference to FIGS. 2B and 2C.

In certain embodiments described in greater detail below with reference to FIG. 2B, the refined iris image is generated using active contour processing of a noise boundary. In such embodiments, an initial estimate of a noise boundary contour is determined based on the intensity data in the initial iris image area defined by the pupillary and limbic boundaries. In one embodiment, the iris image area defined by the pupillary and limbic boundaries is unwrapped into a rectangle by conventional means to permit a determination of a revised noise boundary contour in the unwrapped iris image. After the iris image is unwrapped, the initial estimate of a noise boundary contour is revised by executing an active contour method on the initial estimate of the noise boundary contour. The revised noise estimate is then used as a basis for excluding certain pixels from iris matching operations when comparing the scanned iris to data in a biometric database. In other embodiments of the present invention, the iris image would not be unwrapped prior to application of the active contour method on the initial estimate of the noise boundary contour.

In alternative embodiments described in greater detail below with reference to FIG. 2C, the refined iris image is generated using active contour processing of a polynomial representation of the initial limbic and/or pupillary boundary estimates. In certain such embodiments, an interpolating spline representation of the initial limbic boundary estimate is generated. An active contour method is used to adjust points on this spline interpolation until a revised estimate of the limbic boundary is generated. A refined iris image area defined by this refined limbic boundary and the pupillary boundary may then be generated.

As shown at block 214 of FIG. 2A, once the refined iris image is established using, for example, one of the above methods, the refined iris image is provided to comparing subsystem 102 for comparison to iris image data in a database to determine whether a match exists. As would be appreciated, comparing subsystem 102 may be configured to perform iris encoding operations now known or later developed. In other embodiments, iris encoding may be performed by imaging subsystem 101, or by one or more other components included in imaging system 100.

In one embodiment, initial circular contour estimates of the pupillary and limbic boundaries can be obtained by conventional means such as a circular Hough transform for example, and are typically specified as three scalars per boundary, namely the x and y positions of the circle center and the radius of the circle.

The active contour model (A. Blake and M. Isard, “Active Contours”, 1998, Springer-Verlag) is an integral form intended to characterize a balanced combination of the stiffness, elasticity and interpolation ability of the contour \vec{ν}(s) so that changes may be made to \vec{ν}(s) to optimize the integral form. Specifically, the active contour energy is given by:

$$\begin{matrix}{E}_{snake} = {\int }_{0}^{1} ( {E}_{internal} ( \vec{v} ( s ) ) + {E}_{image} ( \vec{v} ( s ) ) ) + {E}_{con} ( \vec{v} ( s ) ) ) \\ where & ( 1 ) \\ {E}_{internal} = \frac{1}{2} ( α ( s ) {\vert \frac{d \vec{v}}{d s} \vert}^{2} + β ( s ) {\vert \frac{{d}^{2} \vec{v}}{d {s}^{2}} \vert}^{2} ) , & ( 2 ) \\ {E}_{image} = - ∇ I ( x , y ) , & ( 3 ) \\ {E}_{con} = - {( ∇ ( {G}_{σ} ( x , y ) ⋆ I ( x , y ) ) )}^{2} . & ( 4 )\end{matrix}$$

Equation (1), which is an integral over an arc length, is a function of the contour \vec{ν}(s) and may be evaluated multiple times using modified versions of \vec{ν}(s) to find a contour \vec{ν}(s) that achieves a minimum value while balancing the results of equations (2), (3) and (4). Eᵢₙₜₑᵣₙₐₗ (Equation (2)) is a component that weights the amount of elasticity and stiffness in the boundary. The elasticity is measured by the tangent vector magnitude (larger values mean that a point on the curve moves a larger amount, given the same change in the arc length of the parameter (s)). The stiffness is measured by the second derivative vector magnitude and achieves larger values when the boundary \vec{ν}(s) has more curvature given the same change in the arc length parameter(s).

These two contributions are mixed by the scalar weights α and β. E_{image} (Equation (3)) is the negative of the gradient magnitude of the image data at the point \vec{ν}(s); i.e., it is a measure of how much gray scale variation there is in the neighborhood of \vec{ν}(s). This term is minimized when the gradient magnitude is large and in isolation, causes the vertices in \vec{ν}(s) to migrate toward edges in the image. E_{con} (Equation (4)) is the square of a smoothed version of the gradient magnitude and acts in a manner similar to that of E_{image}; in isolation, minimizing it will tend to make the vertices in \vec{ν}(s) approach the edges in the image. The operator ∇(.) is the gradient of its operand, the asterisk * represents the convolution operator, and G_{σ} is a two-dimensional Gaussian smoothing operator with standard deviation σ. Modifying the contour \vec{ν}(s) so as to optimize the energy function with respect to a particular choice of weighting functions α(s) and β(s) and smoothing parameter σ yields a contour that strikes the designed balance between stiffness, elasticity, and ability to interpolate desired positions such as those on the initial contour.

As noted above, the initial circular contour estimates of the limbic and pupillary boundaries may be established by a Hough transform. In one embodiment of the present invention, once the limbic and pupillary boundaries have been established, an initial noise boundary contour is determined by conventional means based on pixel intensity data in the iris image. The noise boundary contour is reflective of local image content such as occluding eyelids and eyelashes for example. This initial estimate of the noise boundary contour is a piece-wise linear approximation of the edge of the eyelid or other occluding object. This approximation is expressed as a contour [symbol] (s). After the initial noise boundary contour estimate is established, the located iris area may be unwrapped into a rectangular image. In one embodiment, the unwrapped image is in a rectangular arrangement of 20×240 pixels. The unwrapping process is well known and described by Daugman, J. G. “High Confidence visual recognition of persons by a test of statistical independence,” IEEE Trans. On Pattern Analysis and Machine Intelligence, vol. 15, pp. 1148-1161, 1993, which is hereby incorporated by reference herein.

After the initial circular contour estimates are unwrapped, the data representing the identified noise boundary contour within the unwrapped iris image is used as input to Equation (1). Specifically, the initial estimate of the noise boundary contour in the iris image is an initial estimate of [symbol] (s) and is used as input to Equation (1). The functions α(s) and β(s) in Equation (2) are chosen empirically to balance the quality of the boundary against its smoothness and ability to shrink or stretch to fit the true boundary in the image. Derivatives in Equation (2) are approximated by central differences or they can be obtained analytically from a functional form of \vec{ν}(s). The image gradient ∇(.) is estimated by finite differences and the smoothing convolution (∇(G_{σ}(x,y)*I(x,y)))² is implemented using a loop abstraction. Thus, in one embodiment of the invention, the initial estimate of the noise boundary contour permits an accurate implementation of Equation (1). The application of Equation (1) is performed iteratively until the energy value is optimized, at which point the iterations are terminated and the resulting revised noise boundary contour is reported as the final result, i.e. the area to be excluded from matching computations. Although embodiments of the present invention are described herein with reference to revision of the initial noise boundary within an unwrapped iris image, it should be appreciated that the initial noise boundary may be revised within an image that has not been unwrapped.

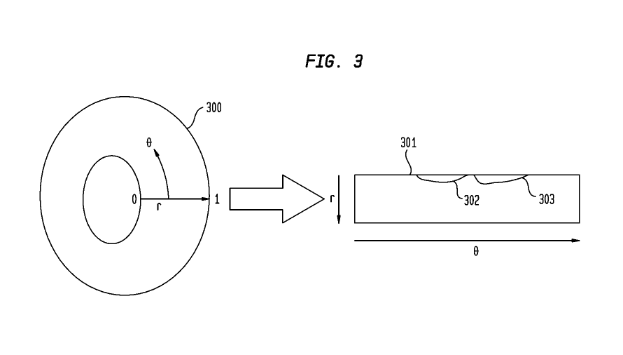

FIG. 2B details the method discussed above. As depicted therein, following an initializing step 202, initial circular contour estimates of the pupillary and limbic boundaries of an iris, respectively, are determined at step 204. These initial estimates may be obtained by performing a Hough transform for example. Once the initial circular contour estimates are obtained in step 204, an initial noise boundary contour is established within the iris image in step 206. The iris image area defined by the limbic and pupillary boundaries generated by the Hough transform is then unwrapped in step 208. In this regard, FIG. 3 depicts the transformation of an iris representation from a circular image to a rectangular image in accordance with this embodiment of the present invention. As depicted therein, when a circular iris image 300 having a radius r is unwrapped, the result is a rectangular image 301 in which the horizontal rows represent contours of constant radius relative to the center of the pupil and vertical columns represent the extent of radius corresponding to the pupillary and limbic boundaries. In one embodiment of the invention, the unwrapped iris image 300 has a resolution of 20×240 pixels. The initial noise boundary contour is established based on the intensity data within the unwrapped image 301, wherein pixels of a higher intensity and contrast are linked to form a boundary contour delineating an area to be excluded from matching computations is shown as noise boundary contour 302. The noise boundary contour 302 reflects occlusions such as an upper eyelid or eyelashes that are to be excluded in a matching analysis. Lower eyelids and eyelashes may also form occlusions which may also be excluded from matching computations. Such an occlusion is depicted as contour 303 of FIG. 3. Once the initial noise boundary contour 302 is determined, the boundary data is used as input to the active contour Equation (1) described above to revise the initial determination of the noise boundary contour. The active contour equation is executed iteratively as depicted in step 210. When an iteration is performed, a determination of whether an optimum value has been reached is reached is made at step 212. If an optimum is not reached, the contour vertices are adjusted at step 216, and steps 210 and 212 are repeated. Once an optimum is reached, the revised estimate of the noise boundary contour is outputted as a result. The revised estimate of the noise boundary contour is then used to delineate an area to be excluded from consideration when the scanned iris data is compared to stored iris data in a biometric database.

FIG. 2C illustrates an alternative method for refining an iris image in accordance with embodiments of the present invention. As depicted therein, following an initializing step 202, initial circular contour estimates of the pupillary and limbic boundaries of an iris, respectively, are determined at step 204. These initial estimates may be obtained by performing a Hough transform for example. Once the initial circular contour estimates are obtained in step 204, at block 218 the estimate of either the pupillary or limbic boundary is converted into a polynomial expression describing the selected boundary. This representation may comprise, for example, an interpolating spline representation. This conversion may be performed using one or more techniques known in the art and thus will not be described herein.

The interpolating spline representation is a polynomial (or rational polynomial) having x and y coordinates for points on the boundary. When graphed, such a spline form can interpolate any desired number of boundary points. As noted, the initial points of the interpolating spline are drawn from the initial estimates described above.

At block 220, an active contour method is used to revise the spline interpolation representation based on intensity data at the boundary of the representation. In other words, this process generates a revised contour estimate of the boundary used to create the spline representation. Referring to embodiments in which a limbic boundary is revised, the x and y coordinates of the spline interpolation are adjusted based on intensity data so that the spline interpolation more closely approximates the limbic boundary of the iris. The active contour method used in these embodiments of the present invention may be substantially similar to the active contour method described above with reference to FIG. 2B.

For example, in one such embodiment, the position space of a point (x,y) on the boundary of the representation is used as an initial estimate of [symbol] (s) and is used as an input to Equation (1). The functions α(s) and β(s) in Equation (2) are chosen empirically to trade the quality of the boundary against its smoothness and ability to shrink or stretch to fit the true boundary in the image. Derivatives in Equation (2) can be approximated by central differences or obtained analytically from the functional form of \vec{ν}(s). The image gradient ∇(.) is estimated by finite differences and the smoothing convolution (∇(G_{σ}(x,y)*I(x,y)))² is implemented using a loop abstraction. Thus, in one illustrative embodiment, the discretized implementation of the continuous-domain theory for the active contour is faithful. Operationally, the control points that define \vec{ν}(s) are moved under the control of a gradient descent procedure to cause the discrete approximation to Equation (1) to be minimized.

As shown, the active contour method may be executed iteratively on the representation of the selected boundary. When an iteration is performed, a determination of whether an optimum refinement of the selected boundary has been reached is made at step 222. If an optimum refinement is not reached, the method returns to block 220 for further adjustment of the representation, and steps 220 and 222 are repeated. More specifically, this iterative procedure continues until the energy value in the active contour processing plateaus. At this point, the iterations terminate and the resulting interpolant function is reported as the optimum refinement. The resulting revised contour estimate of the selected boundary is then used to generate a refined iris image used for iris matching operations. In particular, the revised contour estimate is used to delineate iris image areas to be included/excluded from consideration when the scanned iris data is compared to stored iris data in a biometric database.

In certain embodiments either the pupillary or the limbic boundary may be revised in the above manner. In such embodiments, the refined iris image would be defined by the revised pupillary or limbic boundary, and the initial estimate of the other boundary. In other embodiments, both the pupillary and the limbic boundary may be revised in the above manner. In these embodiments, the refined iris image would be defined by the revised boundaries.

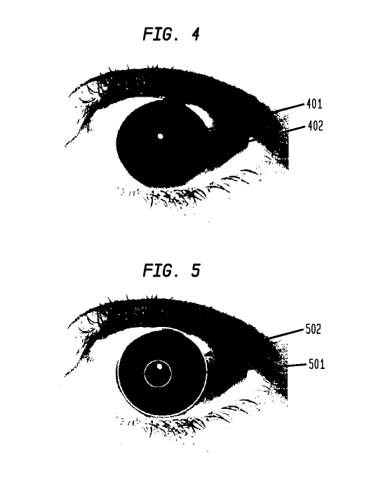

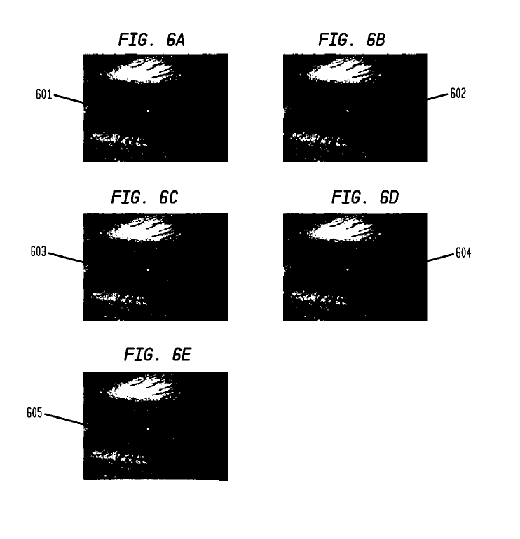

FIGS. 4 thru 6(e) depict the practical effect of an iterative method of certain embodiments of the invention. Referring now to FIG. 4, an image of an eye is shown comprising a pupillary boundary 401 and a limbic boundary 402. In FIG. 5, the pupillary boundary is approximated by a circle 501 and the limbic boundary is approximated by circle 502. Circles 501 and 502 are representations of pupillary and limbic boundaries generated by the execution of any one of a number of different operations on the scanned iris image such as, for example, a Hough transform. In FIG. 6, the progression of the shape of a limbic boundary as a method of the invention is executed is shown. FIG. 6(a) depicts an initial circular estimate 601, of the limbic boundary of an iris. This representation corresponds to the initial scalar estimate of the limbic boundary discussed above which, as can be seen from FIG. 6(a), does not adequately approximate the true boundary due to a variety of reasons, such as a less than optimal initial estimate, occlusion from a partially closed upper eyelid, occlusion due to eyelashes, etc.

Once the iterative process begins however, it can be clearly seen that the limbic boundary curve improves with each successive iteration. These representations of the limbic boundary are contour representations of the limbic boundary of the scanned iris that take into account and exclude local image data, such as noise due to the occluding upper and lower eyelids and eyelashes shown, or image data that falls outside the actual boundary. Thus, as can be seen in FIG. 6(b), limbic boundary 602 is a better approximation than limbic boundary 601 of FIG. 6(a). Similarly, limbic boundary 603 is a better approximation than boundary 601. In FIG. 6(d) limbic circle 604 begins to closely approximate a true representation of the interface of the limbic boundary with the occluding features and in FIG. 6(e) the result of the final iteration depicting limbic boundary 605 is reached. When boundary 605 is compared with the initial scalar result presented as limbic boundary 601 of FIG. 6(a), the benefits of this embodiment of the invention are clearly apparent.

The methods above, while specifically describing the determination of the limbic boundary, are equally applicable to the accurate determination of the pupillary boundary. In this case the pupillary boundary is first approximated by a circle generated by the execution of a Hough transform, or any other known operation, on the scanned iris image. This representation corresponds to the initial scalar estimate of the pupillary boundary which does not adequately approximate the true boundary due to occlusion from the partially closed upper eyelid as well as the non-circularity of the pupil. A more accurate representation of the pupillary boundary takes into account and excludes the local image data (noise), which in this case may comprise the occluding upper and lower eyelids and eyelashes to the extent that they extend into the pupil. Through the use of one or more of the active contours methods described above, the starting point is a circular region within the pupil known to be free of eyelid and eyelash intrusion. The starting circle is iteratively refined until it closely approximates the true pupillary boundary.

As noted above, in certain embodiments of the present invention an obtained iris is segmented to remove regions of the image occluded by, for example, eyelashes and/or eyelids. Such an occluded region is sometimes referred to herein as the eyelid-eyelash noise region.

In one such embodiment, a Canny transform (sometimes referred to herein as a Canny edge detection algorithm or Canny edge detector) is used to detect points within the iris image that correspond to the pupillary and limbic boundaries of the obtained iris image. In operation, the Canny transform uses a Gaussian filter to smooth the iris image. The Canny transform uses a first derivative operator to identify intensity gradients in the smoothed image. The transform evaluates the gradients to determine if a gradient is a local maxima gradient. Non-maxima suppression is used to eliminate intensity gradients which do not correspond to local maxima.

Following the above non-maxima suppression, a threshold comparison is conducted to identify gradients that correspond to edge points. It is generally accepted that intensity gradients having the largest intensity are likely to correspond to edge points. However, it is not possible to specify a threshold intensity at which a given intensity gradient corresponds to an edge point. Thus, the Canny transform uses thresholding with hysteresis to determine which gradients correspond to edges.

Thresholding with hysteresis uses two reference thresholds, a high threshold (T1) and a low threshold (T2), to identify edge points. Specifically, all the gradients that have an intensity which is higher than T1 are marked as edge points. Any other intensity gradients adjacent to one of these identified edge points which have an intensity higher than T2 are also marked as edge points.

After the edges points are identified as described above using the Canny transform, estimates of the pupillary and limbic boundaries can be obtained through the use of, for example, a circular Hough transform. In a circular Hough transform, each of the limbic and pupillary boundaries are specified as three scalars per boundary. These scalars are the position (x, y) of the circle center, and the radius (r) of the circle. During the Hough transform, each edge point generates an estimate of the position (x, y) of the center of boundary to which the edge point corresponds. Each edge point also generates an estimate of the radius (r) of the boundary. These estimates of x, y and r are then used to identify the pupillary and limbic boundaries.

In specific embodiments, an active contour method may be used to refine the limbic and/or pupillary boundaries identified using the Hough transform. This active contour method is optional.

After the pupillary and limbic boundaries are identified, a linear Radon transform is used to define two straight line segments which delineate or model boundaries of the eyelid-eyelash noise region. Because the bounded portions of the iris image are deemed occluded, these regions are removed from the image and thus excluded from iris matching operations.

In certain embodiments of the present invention, a linear Radon transform is used to generate estimates of the boundaries of both the upper and lower eyelids in the obtained iris image. In such embodiments, the obtained iris image is split into four sections of equal size, referred to as a top left section, a top right section, a bottom left section and a bottom right section. The image is split such that there is an overlap of half of the pupil radius between each section. Following division of the iris image, each section has one of the eyelid estimating lines therein. Each such line represent a boundary of the eyelid-eyelash noise region. The eyelid-eyelash noise region is detected in each of these four sections, and the results are joined together to form an iris image from which eyelid-eyelash noise has been removed.

Although embodiments of the present invention have been described herein as refining an iris image using one of the methods described above with reference to FIGS. 2B and 2C, it should be appreciated that in certain embodiments the methods may be used together, sequentially, etc. in order to optimize refinement of the iris image. Furthermore, it should be appreciated that the above embodiments have been described for illustration purposes, and other embodiments for refining an iris image using active contour processing and methods are within the scope of the present invention.

Furthermore, although embodiments of the present invention have been primarily discussed herein with reference to the use of circular estimates of the iris boundaries, it should be appreciated that other estimates may also be used. For example, in certain embodiments elliptical estimates of either of the limbic or pupillary boundaries may be used. These estimates may be generated using any operation or method now know or later developed.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents. All patents and publications discussed herein are incorporated in their entirety by reference thereto.

What is claimed is:

1. A method for determining a contour representation of non-occluded regions of a limbic boundary in an iris image, comprising:
receiving an initial contour estimate of pupillary and limbic boundaries in the iris image which define an iris image area;
determining an initial estimate of a noise boundary contour defining an area containing occluding data points within the iris image;
executing an active contour method on the initial estimate of the noise boundary contour in an unwrapped representation of the iris image area to generate a revised noise boundary contour containing a revised set of occluding data points; and
excluding from the initial contour estimate the revised set of occluding data points to generate a contour estimate of the non-occluded regions of the limbic boundary.

2. The method of claim 1, wherein the initial contour estimate of the pupillary and limbic boundaries results from the execution of a Hough transform on a scanned image of the iris.

3. The method of claim 2, wherein the initial contour estimate is a circular estimate.

4. The method of claim 2, wherein the initial contour estimate is an elliptical estimate.

5. The method of claim 1, wherein the occluded data points comprise at least one of eyelids and eyelashes.

6. The method of claim 1, wherein the active contour method comprises execution of a global objective function that incorporates contour elasticity, smoothness and image gradient value.

7. The method of claim 1, wherein the active contour method is executed iteratively.

8. The method of claim 1, wherein the unwrapped representation of the iris image area comprises a rectangular representation of the iris image area.

9. The method of claim 1, wherein the initial noise boundary contour estimate is determined based on intensity data contained in the iris image.

10. A biometric recognition apparatus for evaluating iris image data comprising:
a receiving portion for receiving iris image data;
a segmentation portion for generating non-occluded iris images by the application of an active contour method;
an encoding portion for encoding iris image texture patterns into digital codes; and
a matching portion for comparing the non-occluded iris images with a database of iris images to determine if a match exists.

11. The biometric recognition apparatus of claim 10, wherein the iris image data comprises an initial circular contour estimate of the pupillary and limbic boundaries of the iris resulting from the execution of a Hough transform on a scanned image of the iris, accompanied by measurements of iris reflectance.

12. The biometric recognition apparatus of claim 11, wherein the non-occluded iris images comprise contour representations of the limbic boundary of the iris with occlusions removed, accompanied by measurements of iris reflectance.

13. The biometric recognition apparatus of claim 12, wherein the occlusions comprise at least one of an eyelid and eyelashes.

14. An iris image recognition apparatus comprising:
an imaging portion for generating and receiving initial circular contour estimates of the pupillary and limbic boundaries of an iris; and
a processing portion operationally coupled to the imaging portion for (1) determining an initial noise boundary contour estimate defining an area containing occluding data points within the iris image, (2) unwrapping the iris image area defined by the initial circular contour estimates of the pupillary and limbic boundaries, and (3) executing an active contour method on the initial noise boundary contour estimate to generate a revised noise boundary contour estimate containing a revised set of occluding data points.

15. The apparatus of claim 14, further comprising:
a comparing portion, for comparing the initial circular pupillary boundary estimate and the limbic boundary estimate excluding the revised set of occluding data points contained in the modified noise boundary contour estimate, to pupillary and limbic boundaries stored in a biometric database to determine whether a match exists.

16. The apparatus of claim 14, wherein unwrapping the iris image area comprises creating a rectangular representation of the iris image area.

17. The apparatus of claim 14, wherein the occluding data points comprise at least one of an eyelid and eyelashes.

18. The apparatus of claim 14, wherein the active contour method comprises execution of a global objective function that incorporates contour elasticity, smoothness and image gradient value.

19. The apparatus of claim 18, wherein the active contour method is executed iteratively.

20. A computer based method for determining a contour representation of non-occluded regions of a limbic boundary in an iris image comprising:
receiving an initial contour estimate of pupillary and limbic boundaries in the iris image which define an iris image area;
determining an initial estimate of a noise boundary contour defining an area containing occluding data points within the iris image;
executing an active contour method on the initial estimate of the noise boundary contour in an unwrapped representation of the iris image area to generate a revised noise boundary contour containing a revised set of occluding data points; and
excluding from the initial contour estimate the revised set of occluding data points to generate a contour estimate of the non-occluded regions of the limbic boundary.

21. The computer based method of claim 22, wherein the initial contour estimate of the pupillary and limbic boundaries results from the execution of a Hough transform on a scanned image of the iris.

22. The method of claim 21, wherein the initial contour estimate is a circular estimate.

23. The method of claim 20, wherein the occluded data points comprise at least one of eyelids and eyelashes.

24. The method of claim 20, wherein the active contour method comprises execution of a global objective function that incorporates contour elasticity, smoothness and image gradient value.

25. The method of claim 24, wherein the active contour method is executed iteratively.

26. The method of claim 20, wherein the unwrapped representation of the iris image area comprises a rectangular representation of the iris image area.

27. The method of claim 21, wherein the initial contour estimate is an elliptical estimate.

28. The method of claim 20, wherein the initial noise boundary contour estimate is determined based on intensity data contained in the iris image.

29. An iris imaging system for obtaining an image of an iris of an eye for identification comprising:
means for imaging the iris; and
means for identifying occluding data points to be excluded from iris matching computations and contour representations of a limbic boundary of the iris by executing an active contour method.

30. The iris imaging system of claim 29, further comprising:
means for comparing a contour representation of the limbic boundary excluding the identified areas to stored iris data.

31. The iris imaging system of claim 29, wherein said imaging means comprises a camera.

32. The iris imaging system of claim 29, wherein the identifying means comprises a computer algorithm.

33. The iris imaging system of claim 29, wherein the active contour method comprises execution of a global objective function that incorporates contour elasticity, smoothness and image gradient value in its solution.

34. The iris recognition system of claim 29, wherein the active contour method is executed iteratively.

35. The iris recognition system of claim 29, wherein the comparing means compares the contour representation of the limbic boundary excluding the occluding data points to archived iris images in a biometric database.

36. The iris recognition system of claim 35, wherein the occluding data points comprise at least one of an eyelid and eyelashes.

37. A method for refining an iris image, comprising:
receiving an initial contour estimate of pupillary and limbic boundaries in the iris image which define an iris image area;
generating a polynomial representation of a selected one of the pupillary and limbic boundaries using the initial contour estimate of the selected boundary;
executing an active contour method on the polynomial representation based on intensity data at the boundary of the representation; and
generating a revised contour estimate of the selected boundary based on the execution of the active contour method thereby causing the revised estimate to more accurately represent the selected boundary.

38. The method of claim 37, wherein said polynomial representation comprises an interpolating spline representation.

39. The method of claim 37, wherein the initial contour estimate of the pupillary and limbic boundaries results from the execution of a Hough transform on a scanned image of the iris.

40. The method of claim 39, wherein the initial contour estimate is a circular estimate.

41. The method of claim 37, wherein the active contour method comprises execution of a global objective function that incorporates contour elasticity, smoothness and image gradient value.

42. The method of claim 37, wherein the active contour method is executed iteratively.

43. The method of claim 37, further comprising:
generating a refined iris image based on the revised contour estimate of the selected boundary.

44. An iris image recognition apparatus comprising:
an imaging portion for generating and receiving initial circular contour estimates of the pupillary and limbic boundaries of an iris; and
a processing portion operationally coupled to the imaging portion configured to (1) generate a polynomial representation of a selected one of the pupillary and limbic boundaries using the initial contour estimate of the selected boundary, (2) execute an active contour method on the polynomial representation based on intensity data at the boundary of the representation, and (3) generate a revised contour estimate of the selected boundary based on the execution of the active contour method thereby causing the revised estimate to more accurately represent the selected boundary.

45. The apparatus of claim 44, wherein the selected boundary comprises the limbic boundary, the apparatus further comprising:
a comparing portion, for comparing an iris image defined by the revised contour estimate of the limbic boundary and the initial circular pupillary boundary estimate to iris image data stored in a biometric database to determine whether a match exists.

46. The apparatus of claim 44, wherein the selected boundary comprises the pupillary boundary, the apparatus further comprising:
a comparing portion, for comparing an iris image defined by the revised contour estimate of the pupillary boundary and the initial circular limbic boundary estimate to iris image data stored in a biometric database to determine whether a match exists.

47. The apparatus of claim 44, wherein processing portion is further configured to generate revised contour estimates of both the pupillary and the limbic boundaries.

48. The apparatus of claim 47, further comprising:
a comparing portion, for comparing an iris image defined by the revised contour estimate of the pupillary boundary and the revised contour estimate of the limbic boundary estimate to iris image data stored in a biometric database to determine whether a match exists.

49. The apparatus of claim 44, wherein the active contour method comprises execution of a global objective function that incorporates contour elasticity, smoothness and image gradient value.

50. The apparatus of claim 44, wherein the active contour method is executed iteratively.

51. A computer based method for refining an iris image, comprising:
receiving an initial contour estimate of pupillary and limbic boundaries in the iris image which define an iris image area;
generating a polynomial representation of a selected one of the pupillary and limbic boundaries using the initial contour estimate of the selected boundary;
executing an active contour method on the polynomial representation based on intensity data at the boundary of the representation; and
generating a revised contour estimate of the selected boundary based on the execution of the active contour method thereby causing the revised estimate to more accurately represent the selected boundary.

52. The computer based method of claim 51, wherein said polynomial representation comprises an interpolating spline representation.

53. The computer based method of claim 51, wherein the initial contour estimate of the pupillary and limbic boundaries results from the execution of a Hough transform on a scanned image of the iris.

54. The computer based method of claim 53, wherein the initial contour estimate is a circular estimate.

55. The computer based method of claim 51, wherein the active contour method comprises execution of a global objective function that incorporates contour elasticity, smoothness and image gradient value.

56. The computer based method of claim 51, wherein the active contour method is executed iteratively.

57. The computer based method of claim 53, wherein the initial contour estimate is an elliptical estimate.

58. The computer based method of claim 51, further comprising:
generating a refined iris image based on the revised contour estimate of the selected boundary.

57. A system method for refining an iris image, comprising:
means for receiving an initial contour estimate of pupillary and limbic boundaries in the iris image which define an iris image area;
means for generating a polynomial representation of a selected one of the pupillary and limbic boundaries using the initial contour estimate of the selected boundary;
means for executing an active contour method on the polynomial representation based on intensity data at the boundary of the representation; and
means for generating a revised contour estimate of the selected boundary based on the execution of the active contour method thereby causing the revised estimate to more accurately represent the selected boundary.

58. The system of claim 57, wherein said polynomial representation comprises an interpolating spline representation.

59. The system of claim 57, wherein the initial contour estimate of the pupillary and limbic boundaries results from the execution of a Hough transform on a scanned image of the iris.

60. The system of claim 59, wherein the initial contour estimate is a circular estimate.

61. The system of claim 57, wherein the active contour method comprises execution of a global objective function that incorporates contour elasticity, smoothness and image gradient value.

62. The system of claim 57, wherein the active contour method is executed iteratively.

63. The method of claim 57, further comprising:
means for generating a refined iris image based on the revised contour estimate of the selected boundary.

64. A method for determining a contour representation of non-occluded regions of a limbic boundary in an iris image, comprising:
receiving an initial contour estimate of pupillary and limbic boundaries in the iris image which define an iris image area;
determining an initial estimate of a noise boundary contour defining an area containing occluding data points within the iris image;
executing an active contour method on the initial estimate of the noise boundary contour generate a revised noise boundary contour containing a revised set of occluding data points; and
excluding from the initial contour estimate the revised set of occluding data points to generate a contour estimate of the non-occluded regions of the limbic boundary.

65. The method of claim 64, wherein executing an active contour method on the initial estimate comprises:
executing an active contour method on the initial estimate in an unwrapped representation of the iris image area.

66. The method of claim 64, wherein the initial contour estimate of the pupillary and limbic boundaries results from the execution of a Hough transform on a scanned image of the iris.

67. The method of claim 66, wherein the initial contour estimate is a circular estimate.

68. The method of claim 66, wherein the initial contour estimate is an elliptical estimate.

69. The method of claim 64, wherein the occluded data points comprise at least one of eyelids and eyelashes.

70. The method of claim 64, wherein the active contour method comprises execution of a global objective function that incorporates contour elasticity, smoothness and image gradient value.

71. The method of claim 64, wherein the active contour method is executed iteratively.

72. The method of claim 64, wherein the unwrapped representation of the iris image area comprises a rectangular representation of the iris image area.

73. The method of claim 64, wherein the initial noise boundary contour estimate is determined based on intensity data contained in the iris image.

74. A method for segmentation of an obtained iris image having at least one occluded region therein, comprising:
performing a Canny transform on the obtained iris image to identify intensity gradients representing edge points within the iris image;
performing a circular Hough transform on a plurality of the edge points to identify the pupillary and limbic boundaries within the iris image;
performing at least one Radon transform to define two straight line segments each representing a boundary of the occluded region, wherein the occluded region is further bounded by one or more borders of the image; and
removing the region bounded by the two straight line segments and the one or more borders from the iris image.

75. The method of claim 74, wherein the at least one occluded region comprises a region of the iris image which is occluded by one or more of an eyelid and an eyelash.

76. The method of claim 75, wherein the at least one occluded region comprises first and second occluded regions, and wherein the method further comprises:
performing at least one Radon transform to define two straight line segments each representing a boundary the first occluded region, wherein the first occluded region is further bounded by one or more borders of the image; and
performing at least one Radon transform to define two straight line segments each representing a boundary of the second occluded region, wherein the second occluded region is further bounded by one or more borders of the image; and
removing the first and second bounded occluded regions from the iris image.

77. The method of claim 74, further comprising:
refining with an active contour method one or more of the pupillary boundary and the limbic boundary obtained by the circular Hough transform.

78. The method of claim 74, wherein the circular Hough transform identifies the size and location of the pupillary and limbic boundaries.

79. The method of claim 74, wherein the circular Hough transform identifies the pupillary boundary before identifying the limbic boundary.

80. A biometric recognition apparatus for evaluating a received iris image having at least one occluded region therein, comprising:
a segmentation portion for generating non-occluded iris images, comprising:
an edge point detection module configured to identify intensity gradients representing edge points within the iris image,
an identification module configured to use the edge points to identify the pupillary and limbic boundaries within the iris image,
a boundary module configured to define two straight line segments each representing a boundary of the occluded region, wherein the occluded region is further bounded by one or more borders of the image, and
a removal module configured to remove the region bounded by the two straight line segments and the one or more borders from the iris image; and
a matching portion for comparing the non-occluded iris image with a database of iris images to determine if a match exists.

81. The apparatus of claim 80, wherein said edge point detection module is configured to implement a Canny transform to identify the intensity gradients.

82. The apparatus of claim 80, wherein the identification module is configured to implement a circular Hough transform on a plurality of the edge points to identify the pupillary and limbic boundaries.

83. The apparatus of claim 80, wherein the boundary module is configured to implement at least one Radon transform to define the two straight line segments.

84. The apparatus of claim 80, further comprising:
an encoding portion configured to encode the non-occluded iris image into a digital code for use in the comparison with the database of iris images.

85. The apparatus of claim 80, wherein the at least one occluded region comprises a region of the iris image which is occluded by one or more of an eyelid and an eyelash.

86. The apparatus of claim 80, further comprising:
a refinement module configured to implement an active contour method to refine one or more of the identified pupillary and limbic boundaries.

87. The apparatus of claim 82, wherein the circular Hough transform identifies the pupillary boundary before identifying the limbic boundary.

88. An apparatus for segmentation of an obtained iris image having at least one occluded region therein, comprising:
means for performing a Canny transform on the obtained iris image to identify intensity gradients representing edge points within the iris image;
means for performing a circular Hough transform on a plurality of the edge points to identify the pupillary and limbic boundaries within the iris image;
means for performing at least one Radon transform to define two straight line segments each representing a boundary of the occluded region, wherein the occluded region is further bounded by one or more borders of the image; and
means for removing the region bounded by the two straight line segments and the one or more borders from the iris image.

89. The apparatus of claim 88, wherein the at least one occluded region comprises a region of the iris image which is occluded by one or more of an eyelid and an eyelash.

90. The apparatus of claim 89, wherein the at least one occluded region comprises first and second occluded regions, and wherein the apparatus further comprises:
means for performing at least one Radon transform to define two straight line segments each representing a boundary the first occluded region, wherein the first occluded region is further bounded by one or more borders of the image; and
means for performing at least one Radon transform to define two straight line segments each representing a boundary of the second occluded region, wherein the second occluded region is further bounded by one or more borders of the image; and
means for removing the first and second bounded occluded regions from the iris image.

91. The apparatus of claim 88, further comprising:
means for refining with an active contour method one or more of the pupillary boundary and the limbic boundary obtained by the circular Hough transform.

92. The apparatus of claim 88, wherein the circular Hough transform identifies the size and location of the pupillary and limbic boundaries.

93. The apparatus of claim 88, wherein the circular Hough transform identifies the pupillary boundary before identifying the limbic boundary.
